(19) United States
(12) Patent Application Publication
(10) Pub. No.: US 2022/0366432 A1
(43) Pub. Date: Nov. 17, 2022

(54) AUTOMATED PRODUCT COMPLIANCE ANALYSIS

(71) Applicant: FoodChain ID Group, Inc., Washington, DC (US)

(72) Inventors: Russell Singleton, Seattle, WA (US); Wesley Frierson, Seattle, WA (US)

(21) Appl. No.: 17/731,081

(22) Filed: Apr. 27, 2022

Related U.S. Application Data
(60) Provisional application No. 63/187,856, filed on May 12, 2021.

(51) Int. Cl. G06Q 30/00

(52) U.S. Cl. CPC G06Q 30/0185

(57) ABSTRACT

A device for product compliance comprising one or more memories in communication with one or more processors. The one or more processors configured to receive information about a plurality of regulations; receive information about a plurality of products; compare each of the plurality of products simultaneously with each of the plurality of regulations; flag one or more products from the plurality of products in response to the one or more products satisfying a condition with the plurality of regulations; generate a compliance result for each of the one or more flagged products; and aggregate the compliance result for each of the one or more flagged products.

### CROSS-REFERENCE TO RELATED APPLICATIONS

This application claims the benefit of U.S. Provisional Application No. 63/187,856, filed May 12, 2021, entitled “Automated Product Compliance Analysis,” the disclosure of which is incorporated herein by reference.

### BACKGROUND

### Technical Field

The present disclosure relates to compliance analysis across multiple databases. More particularly, and not by way of limitation, the present disclosure is directed to a device, system and method for determining compliance of a plurality of products with a plurality of regulations.

### Description of Related Art

In process manufacturing, it is common to create a product that needs to be distributed globally. The rules or regulations for what is allowed in a product vary from country to country. Currently, compliance technology allows businesses to enter their product information and screen the information against a set of country or region-specific rules or regulations. The current compliance technology is not integrated with data management systems, which inhibits workflow automation between generating the product data and analyzing the compliance. Further, current compliance technology requires screening individual products against individual markets.

It would be advantageous to have a device, system, and method for bulk screening of multiple products simultaneously against multiple regulations that overcomes the disadvantages of the prior art. The present disclosure provides such a device, system, and method.

### BRIEF SUMMARY

This summary provides a discussion of aspects of certain embodiments of the disclosure. It is not intended to limit the disclosure or any of the claimed subject matter. The summary provides some aspects, but there are aspects and embodiments of the disclosure that are not discussed here.

In one aspect, the present disclosure is directed to a computing device for product compliance that may include one or more memories communicatively coupled to one or more processors. The one or more processors may be configured to: compare each of a plurality of products simultaneously against each of a plurality of regulations; flag one or more products from the plurality of products in response to the one or more products satisfying a condition with the plurality of regulations; aggregate the one or more flagged products; and produce compliance results, wherein the compliance results are a pre-defined dataset formatted with a pre-defined format.

In another aspect, the present disclosure is directed to a method for product compliance that may include: receiving, by one or more computing resources of a compliance platform, information about a plurality of regulations; receiving, by the one or more computing resources of the compliance platform, information about a plurality of products; comparing, by the one or more computing resources of the compliance platform, each of the plurality of products simultaneously with each of the plurality of regulations; flagging, by the one or more computing resources of the compliance platform and based on the comparison of each of the plurality of products simultaneously with each of the plurality of regulations, one or more products from the plurality of products in response to the one or more products satisfying a condition with the plurality of regulations; generating, by the one or more computing resources of the compliance platform and based on the one or more flagged products, a compliance result for each of the one or more flagged products; and aggregating, by the one or more computing resources of the compliance platform, the compliance result for each of the one or more flagged products.

In yet another aspect, the present disclosure is directed to a non-transitory computer-readable medium that may store instructions. The instructions may include one or more instructions that, when executed by one or more processors, cause the one or more processors to: receive information about a plurality of regulations; receive information about a plurality of products; compare each of the plurality of products simultaneously with each of the plurality of regulations; flag one or more products from the plurality of products in response to the one or more products satisfying a condition with the plurality of regulations; generate a compliance result for each of the one or more flagged products; and aggregate the compliance result for each of the one or more flagged products.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIGS. 1A-1B are diagrams of an overview of an embodiment of an implementation described herein.

FIG. 2 is a diagram of an embodiment of an environment in which systems and/or methods, described herein, may be implemented.

FIG. 3 is a diagram of example components of one or more devices of FIG. 2.

FIGS. 4A-4B are flow charts of an embodiment for product compliance analysis.

FIG. 5 is an illustration of an embodiment of product and regulation information used in product compliance analysis.

FIG. 6 is an illustration of an embodiment of compliance results used in product compliance analysis.

FIG. 7 is an illustration of an embodiment of detailed results used in product compliance analysis.

### DETAILED DESCRIPTION

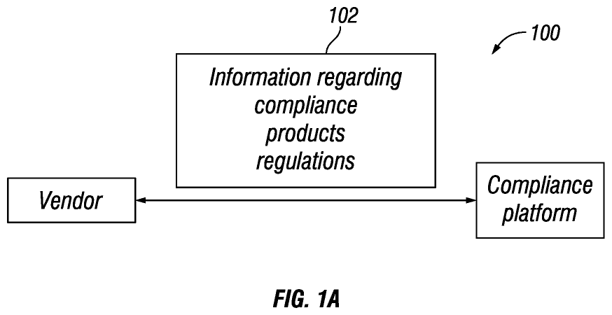

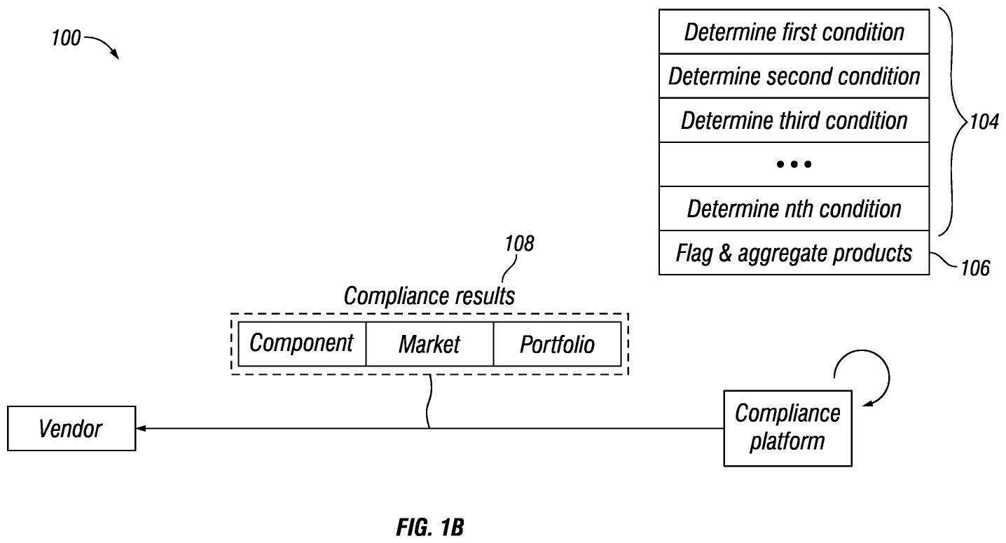

FIGS. 1A-1B are diagrams of an overview of an embodiment of an implementation 100 described herein. As shown in FIG. 1A, and by reference number 102, an entity associated with a vendor device and an entity associated with a compliance platform may exchange information regarding products, regulations, and compliance of the products with the regulations. In at least one embodiment, products are a set of ingredients where the compliance platform analyzes, exchanges, and/or recommends changes to the ingredients or components of a product. For example, a vendor device may provide the compliance platform with product information to be analyzed against specified regulations. The compliance platform analyzes the specified products against the specified regulations and produces compliance results for the products to the vendor device. In some examples, the vendor device can be at least one vendor computing device that is in communication with at least one compliance computing device executing analysis, compliance, recommendation, and/or regulation programs or applications in a software form from a computer readable medium. Further to these examples, the at least one compliance computing device can access a plurality of regulation databases, ingredient and/or product databases based on commands executed from the analysis, compliance, recommendation, and/or regulation programs or applications. The connections that allow for the communications between computing devices, and/or databases can include wireless, and wired communication networks. A wired connection may include coaxial, network (CATS or similar), HDMI, component, USB, Firewire, Lightning, Thunderbolt, or other similar wired connections capable of transmitting video, audio, data, or a combination thereof a specified distance. A wireless connection may include WLAN (wireless local area network), Bluetooth, Zigbee, NFC (Near Field Communication), or other wireless communication protocols that allow for the transmission of video, audio, data, or a combination thereof a specified distance.

As shown in FIG. 1B, in one example, during the analysis of the products against the regulations, the compliance platform may determine 104 whether the products satisfy a condition with the regulations. After the products have been analyzed against the regulations, the compliance platform products compliance results 108 to the vendor device. The compliance results may contain information related to the compliance of components in each of the products, compliance of the products in different regulatory markets, and/or compliance of the products across the analyzed portfolio of products.

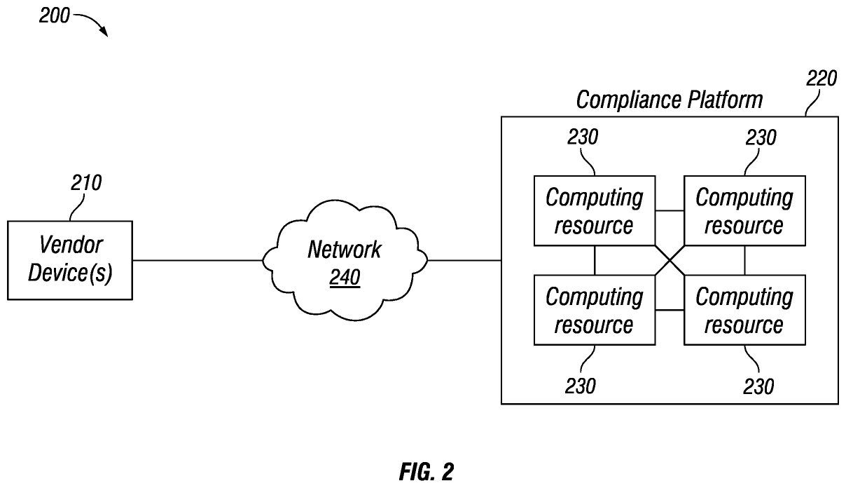

Referring to FIG. 2, a diagram of an embodiment of an environment 200 in which systems and/or methods may be implemented is illustrated. As shown if FIG. 2, the environment 200 may include a vendor device 210, a compliance platform 220, a computing resource 230, and a network 240. Device of environment 200 may interconnect via wired connections, wireless connections, or a combination of wired and wireless connections.

The vendor device 210 includes one or more devices capable of receiving, generating, storing, processing, and/or providing information associated with a software environment. For example, the vendor device 210 may include a user device (e.g., a laptop computer, a desktop computer, etc.), a computing device, a server, a group of servers, and/or the like. In some embodiments, the vendor device 210 may be implemented in a cloud environment. For example, vendor device 210 may be implemented by one or more computer devices of a cloud computing environment or a data center.

The compliance platform 220 includes one or more devices capable of receiving, generating, storing, processing, and/or providing information associated with determining compliance of products with regulations. For example, the compliance platform 220 may include a server, a group of servers, and/or the like. In some embodiments, the compliance platform 220 may be partially or entirely implemented in cloud computing environment.

A cloud computing environment includes an environment that delivers computing as a service, whereby shared resources, services, etc. may be provided to the vendor device 210 and/or compliance platform 220. A cloud computing environment may provide computation, software, data access, storage, and/or other services that do not require end-user knowledge of a physical location and configuration of a system and/or a device that delivers the services.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

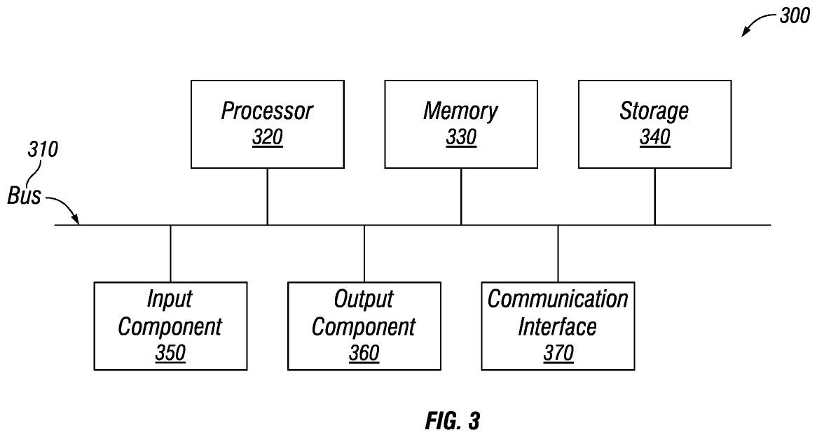

Referring to FIG. 3, a diagram of example components of a device 300. The device 300 may correspond to the vendor device 210 and/or computing resource 225. In some embodiments, the vendor device 210 and computing resource 225 may include one or more devices 300 and/or one or more components of the device 300. As shown in FIG. 3, the device 300 may include a bus 310, a processor 320, a memory 330, a storage component 340, an input component 350, an output component 360, and a communication interface 370.

Bus 310 includes a component that permits communication among the components of the device 300. Processor 320 is implemented in hardware, firmware, or a combination of hardware and software. The processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits the device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on the processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

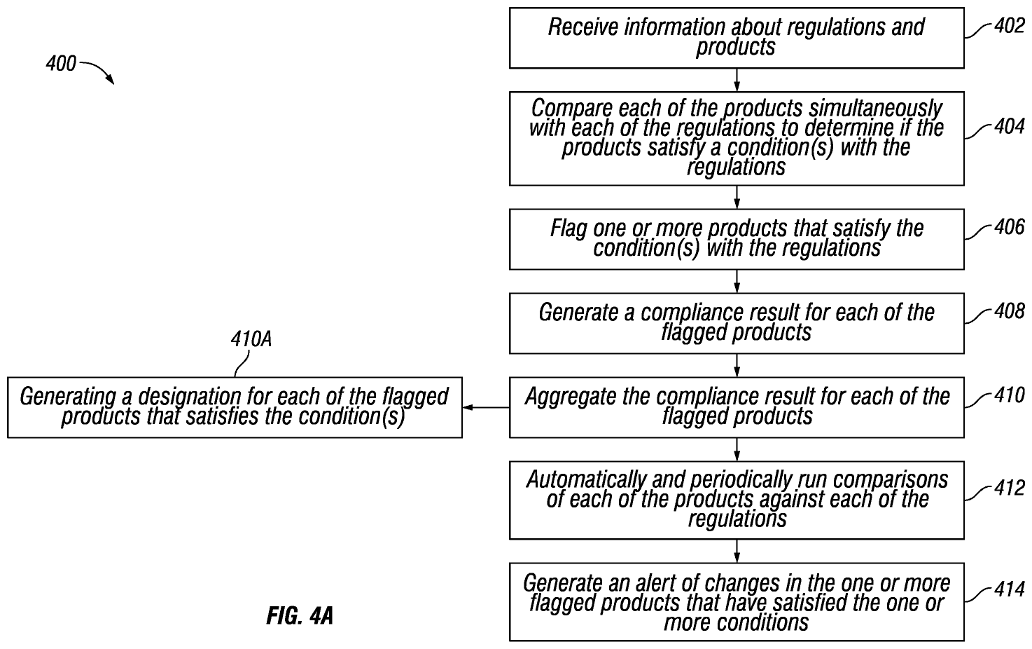

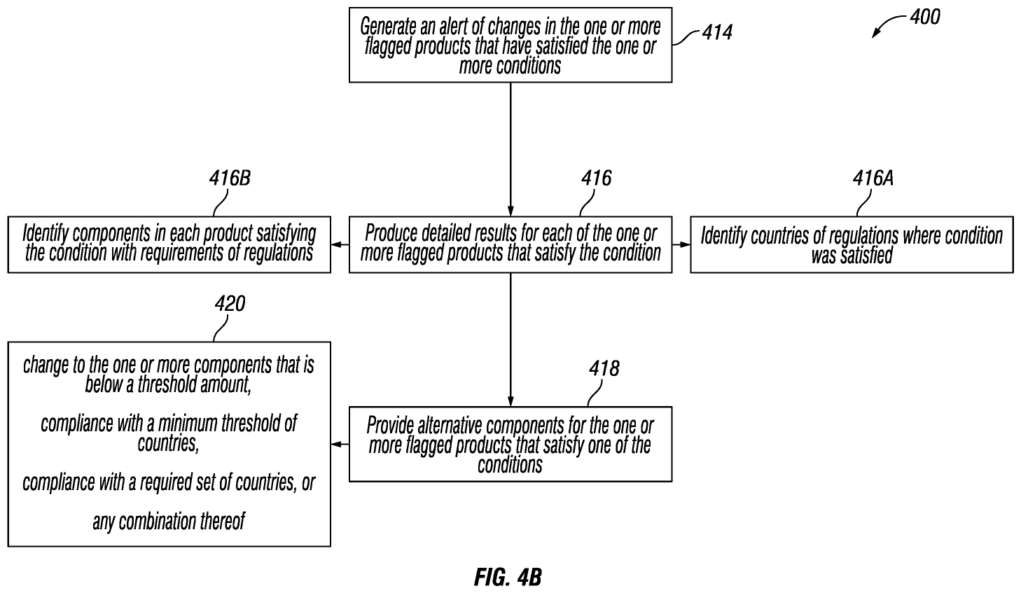

Referring to FIGS. 4A-4B, flow charts of an embodiment of a process 400 for product compliance analysis are illustrated. In some embodiments, one or more process blocks of FIGS. 4A-4B may be performed by the compliance platform 220. In some embodiments, one or more process blocks of FIGS. 4A-4B may be performed by another device or a group of devices separate from or including compliance platform 220, such as the vendor device 210.

As shown in FIG. 4A, the process 400 may include receiving 402 information identifying a plurality of regulations and a plurality products. In at least one embodiment, the plurality of products are a plurality of ingredient sets. For example, the compliance platform 220 may receive (e.g., using computing resource 225, processor 320, communication interface 370, and/or the like) product information and/or regulation information. The product information may include information for determining whether the components or ingredients of each product is compliant with the requirements of each regulation. For example, the product information may include the type of product being analyzed (e.g., food, beverage, cosmetics, medications). The product information may include the components of the products being analyzed (e.g., food/beverage class, chemical composition, formulation, and function). The regulation information may include requirements concerning the type of product being analyzed (e.g., almonds not allowed in country “X”). The regulation information may include requirements concerning the components of the products being analyzed (e.g., roasted almonds not allowed to have SiO₂ levels above “X” weight percent). In at least one embodiment, the regulation information is formed into one or more regulation rule sets for each country, and/or type of product being analyzed. For example, iron filings may be permissible in cosmetics and medications but not permissible for food and beverages.

In some implementations, the compliance platform 220 may receive the product information from vendor device 210. Additionally, or alternatively, compliance platform 220 may receive the product information from a user device associated with compliance platform 220. The user device may be connected through a communication network or via the vendor.

As further shown in FIG. 4A, the process 400 may include comparing 404 each of the plurality of products simultaneously with each of the plurality of regulations to determine whether the plurality of products satisfy one or more conditions with the plurality of regulations. For example, the compliance platform 220 may determine (e.g., using computing resource 225, processor 320, and/or the like) that one or more of the plurality of products satisfy a condition with one or more regulations from the plurality of regulations.

In at least one embodiment, the process 400 includes comparing 404 each of the plurality of products simultaneously with each of the plurality of regulations to determine whether the plurality of products satisfy a condition with the plurality of regulations. In one example, the process 400 includes comparing 404 each of the plurality of products simultaneously with each of the plurality of regulations to determine whether the plurality of products satisfy two conditions with the plurality of regulations. In yet another example, the process 400 includes comparing 404 each of the plurality of products simultaneously with each of the plurality of regulations to determine whether the plurality of products satisfy three conditions with the plurality of regulations. Three examples of conditions, described herein, are where: one or more of the plurality of products match with each of the regulations; any one of the plurality of products does not match with any of the plurality of regulations, and one or more of the plurality of products does not have a regulations to be compared with. Each is described in turn below. The plurality of regulations may be gathered from a plurality of databases, and then formed into a plurality of regulation rules set that allow for efficient analysis by the computing devices.

A condition may be satisfied where one or more of the plurality of products match with each of the regulations. In one embodiment, when each of the plurality of products comprises one or more components and each of the plurality of regulations comprises one or more requirements, the condition may be satisfied when each of the one or more components match each of the one or more requirements. Below is an example of multiple scenarios related determining whether a condition has been satisfied. In each example, the plurality of products are Product A, Product B, and Product C that have one component each. The plurality of regulations are two regulations that have a one requirement.

In one example, Product A, Product B, and Product C each have one component: chemical composition “Sift.” The plurality of regulations have a requirement that corresponds to each component of Products A-C, such as the chemical composition is permitted below a certain threshold (e.g., <2 ppm of SiO₂). Products A-C each have a chemical composition of below 2 ppm of SiO₂, Products A-C and satisfy the conditions of both regulations. In another example, Products A and B have a chemical composition above 2 ppm of SiO₂ and Product C have a chemical composition 2 ppm of SiO₂, Product C would satisfy the condition and Products A and B would not satisfy the regulations.

A condition may also be satisfied where one or more of the plurality of products does not match with a regulation. In a second scenario, Products A and B have a chemical composition above 2 ppm of SiO₂ and Product C had a chemical composition 2 ppm of SiO₂, Products A and B would satisfy the condition of both regulations and Product C would not satisfy the regulation.

A condition may also be satisfied where one or more of the plurality of products does not have a regulation to be compared with. In a third scenario, Products A and B have SiO₂ as the single component and Product C has SO₂ as its single component. The two regulations have one requirement that only corresponds to SiO₂ below a certain threshold (e.g., <2 ppm of SiO₂). Product C would satisfy the condition because it has a component that does not have a requirement to be compared with and Products A and B would not satisfy the condition.

As noted above, some examples may have multiple conditions that used in the comparison of the plurality of products simultaneously with each of the plurality of regulations. Thus, any combination of the above conditions may be used in the comparison of the plurality of products simultaneously with each of the plurality of regulations.

As further shown in FIG. 4A, the process 400 may include flagging 406, based on the comparison of each of the plurality of products simultaneously with each of the plurality of regulations, one or more products from the plurality of products in response to the one or more products satisfying a condition with the plurality of regulations. For example, the compliance platform 220 may flag (e.g., using computing resource 225, processor 320, communication interface 370, and/or the like) the one or more products from the plurality of products that satisfy a condition with the plurality of regulations. Flagging 406 may function as a signal for end user that is reviewing which product(s) have satisfied a condition. For instance, in the example above where Products A and B have a chemical composition above 2 ppm of SiO₂ and Product C had a chemical composition 2 ppm of SiO₂, Products A and B would be flagged so that the end user may identify which products have satisfied a particular condition. Step 406 may be performed remotely or by another entity. For example, step 406 may be carried out by calling to an interface (e.g., an application programming interface) to execute the step.

With continued reference to FIG. 4A, the process 400 may further include generating 408 a compliance result for each of the one or more flagged products. For example, the compliance results may include information concerning the plurality of products that were selected for analysis according to various regulations. Step 408 may be performed remotely or by another entity. For example, step 408 may be carried out by calling to an interface (e.g., an application programming interface) to execute the step. The process 400 may include aggregating 410 the one or more flagged products. For example, the compliance platform 220 may aggregate (e.g., using computing resource 225, processor 320, communication interface 370, and/or the like) the one or more flagged products. For instance, in the example above where Products A and B have a chemical composition above 2 ppm of SiO₂ and Product C had a chemical composition 2 ppm of SiO₂, after Products A and B are designated as non-compliant with the two regulations, their designation are aggregated for review by the end user. Details regarding aggregation are described elsewhere herein. Thus, the end user would know at one time the non-compliance status of Products A and B. Aggregation is a beneficial step for the end user because aggregation enables the end user to review the status of each product across all of the analyzed products, which is beneficial to the end user determining which scenario of products will provide the best compliance. Additionally, aggregation enables the end user to make changes earlier in the manufacturing process, which enables the end user to maximize opportunities in various markets and minimize risk of non-compliance.

As further shown in FIG. 4A, the process 400 may include generating 410A a designation for the one or more flagged products that satisfy the one or more conditions. For example, the compliance platform 220 may provide (e.g., using computing resource 225, processor 320, communication interface 370, and/or the like) a designation for the one or more flagged products from the plurality of products that satisfy a condition with the plurality of regulations. Generating a designation may provide an identification and/or description of each of the one or more flagged products to the end user. For instance, in the example above where Products A and B have a chemical composition above 2 ppm of SiO₂ and Product C had a chemical composition 2 ppm of SiO₂, Products A and B would be designated as non-compliant with the two regulations. Details regarding designation are described elsewhere herein. Thus, the end user would know that changes would need to be made to Products A and B to obtain compliance with the regulations.

The process 400 may include automatically and/or periodically comparing 412 information about the plurality of products with the information about a plurality of regulations, and generating 414 an alert upon changes in the one or more flagged products that have satisfied the condition. Similarly, the compliance platform may analyze the plurality of regulation rule sets to determine where commonalities and differences are to allow for decreased computation and increased computing efficiency. For example, compliance analysis may be configured to provide re-evaluation of the plurality of products based on time (e.g., every three months) and or change in compliance (e.g., compliant to non-compliant). The period analysis enables an end user to proactively make necessary changes to comply with a particular regulation at an earlier time in production of product, which could save time, money, and/or resources. The alternative components may include a default recommendation of alternative components based on, for example, cost or availability. For example, the default recommended alternatives may be set to the cheapest alternatives at a given time (e.g., present time, future trading price, etc.). The default recommended alternatives may be set to the alternatives that are available on the market at a given time. Additionally, or alternatively, the end user may configure the default recommended alternatives to be a predefined set.

The simultaneous comparison in the process 400 of the plurality of products with the plurality of regulations is advantageous because the end user avoids the labor-intensive process of conducting the analysis of individual products on an “as needed” basis. Instead, the end user is able to instantly analyze multiple scenarios of various products to determine which scenario provides the best compliance. Additionally, the process 400 may be implemented by an user (e.g., research and development) and at any stage (e.g., as early as development) to receive insights on compliance that can be leveraged early and avoid costly delays, rework, and missed market opportunities.

As shown if FIG. 4B, the process may include producing 414 compliance results of the plurality of products. For example, the compliance platform 220 may produce compliance results (e.g., using computing resource 225, processor 320, communication interface 370, and/or the like) of the plurality of products. In some examples, the process 400 produces compliance results for each of the plurality of products that are analyzed. For instance, in the example above where Products A and B have a chemical composition above 2 ppm of SiO₂ and Product C had a chemical composition 2 ppm of SiO₂, after Products A and B are designated as non-compliant with the two regulations, the aggregated flagged products are produced for review by the end user. Details regarding compliance results are described elsewhere herein.

As further shown if FIG. 4B, the process 400 may include generating 416 detailed results for each of the one or more flagged products that satisfy the second condition. For example, the compliance platform 220 may generate detailed results (e.g., using computing resource 225, processor 320, communication interface 370, and/or the like) of the one or more flagged products. The detailed results may include identification 416B of the one or more components for each of the one or more flagged products that satisfy the one or more conditions. The detailed results may additionally, or alternatively, include identification 416A of one or more countries where the one or more flagged products satisfy the condition. Details detailed compliance results are described elsewhere herein

As further shown in FIG. 4B, the process may include providing 418 alternative components for the one or more flagged products to create a match with the at least one of the plurality of requirements. For example, the compliance platform 220 may provide alternative components (e.g., using computing resource 225, processor 320, communication interface 370, and/or the like) for the one or more flagged products. The alternative components may result 420 in a change to the one or more components that is below a threshold amount. For example, the end user may seek to obtain compliance by changing the fewest number of components and may set a maximum threshold of between one and one hundred components that may be changed. The alternative components may additionally, or alternatively, result 420 in compliance with a minimum threshold of countries. For example, the end user may seek to obtain the broadest compliance in the most economical means and may set a minimum threshold of between 40 percent and 100 percent of countries that the products comply with the regulations. The alternative components may additionally, or alternatively, result 420 in compliance with a required set of countries. For example, the end user may seek to obtain compliance with specific countries (e.g., countries X, Y, and Z) and may set a country requirement that provides alternative components to ensure compliance with countries X, Y, and Z.

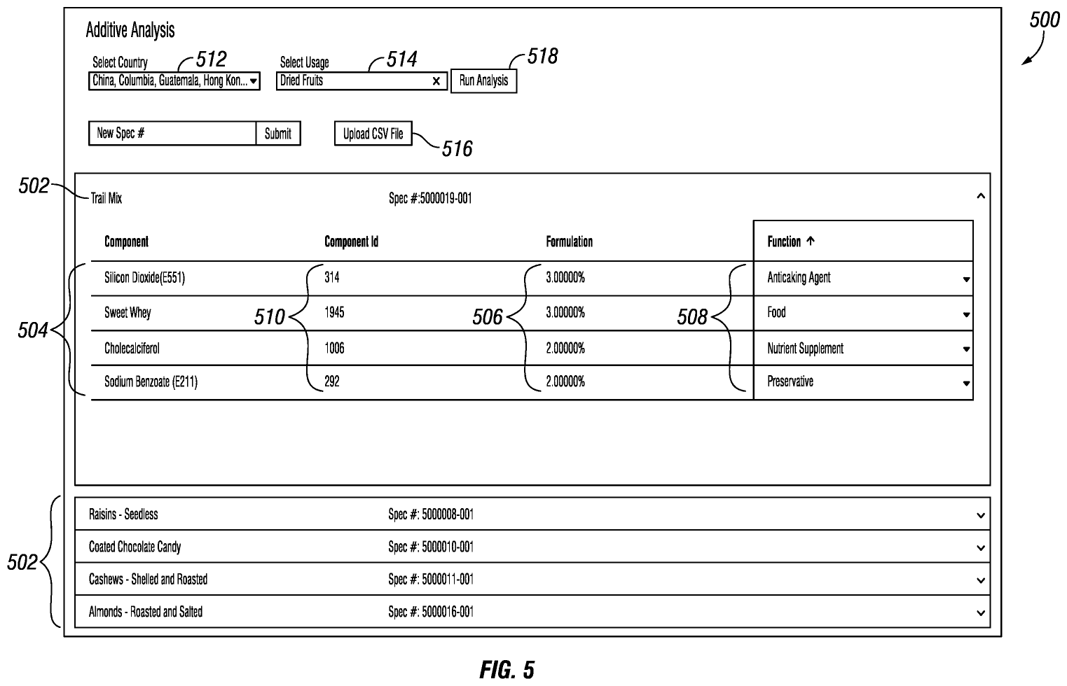

Referring to FIG. 5, an embodiment of product and regulation information used in product compliance analysis is illustrated. As shown in FIG. 5, an interface 500 is provided to an end user on a device 300 such as, for example, on a communication interface 370. In some examples, the device 300 is a vendor device 210 and/or compliance platform 220. The interface 500 allows an end user to input and select of information for compliance analysis. The interface 500 may include information regarding the one or more products 502 that are to be analyzed for compliance. The product information 502 may include the components 504 of the product, the formulation 506 of the product, function 508 of the product, and/or the identification 510 of the product.

As shown in FIG. 5, the interface 500 may include information regarding the one or more regulations 512 that are to be used to analyze the products for compliance. The regulation information 512 may include one or more countries.

As shown in FIG. 5, the interface 500 may include information regarding the usage 514 of the products. For example, the one or more products might be used as dried fruit instead of fresh fruit, which may necessitate compliance with different requirements of the regulations in the one or more countries.

As shown in FIG. 5, the end user may provide information, such as product information, by transmitting 516 the product information to the device 300. In one example, the end user has information for one or more products stored in a database. The end user saves the information for the one or more products in a tabular format such as, for example, a comma-separated value file or the like. The end user transmits 516 the information for the one or more products to the device 300. The device 300 populates the various fields (502-510) with the information for the one or more products. Once the product and regulation information is provided to the device 300, the end user executes the command to analyze 518 the product and regulation information for compliance. The ability of the end user to load information having multiple products and retrieve the compliance results automatically is beneficial because the end user does not have to analyze information for one product at a time. Further, the ability for an end user to specify the product information and requirements for the regulations prior to analysis is beneficial because the end user will not receive superfluous information that may necessitate time-consuming data filtration.

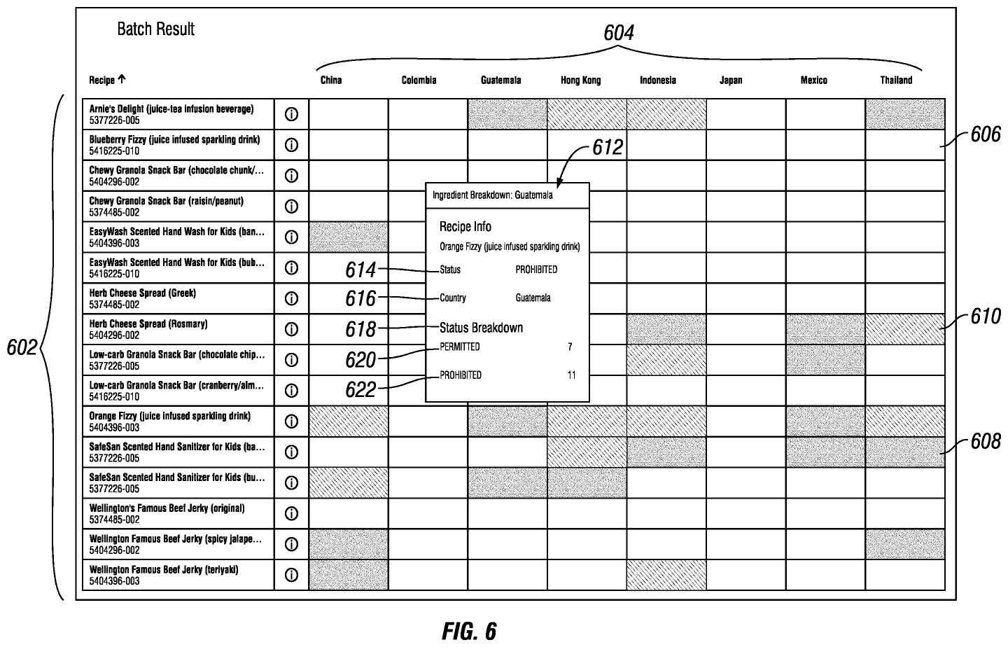

Referring to FIG. 6, an embodiment of compliance results used in product compliance analysis is illustrated. As shown in FIG. 6, an interface 600 is provided to an end user on a device 300 such as, for example, on a communication interface 370. In some examples, the device 300 is a vendor device 210 and/or compliance platform 220. The interface 600 may include information regarding the plurality of products 602 that were selected to be analyzed for compliance and the various countries 604 that were selected to analyze the compliance of the plurality of products. The compliance results may include aggregating the information about the plurality of products that were flagged during the analysis. The compliance results may include displaying designations for the flagged products. The designations may include compliant 606 for products in a given country, non-compliant 608 for products in a given country, and not-listed 610 for products in a given country. Further, designation may include color indicators such as, for example: green for compliant products, red for non-compliant products, and yellow for not-listed products. The color indicators may comprise any other set of colors corresponding to the designations. The compliance results may include a breakdown 612 for each country and/or product. The breakdown 612 may include information regarding the status (e.g., permitted, prohibited, etc.) of the product 614 in a country 616. The breakdown 612 may include information regarding the status 618 of all products (e.g., permitted 620, prohibited 622, etc.) in a country.

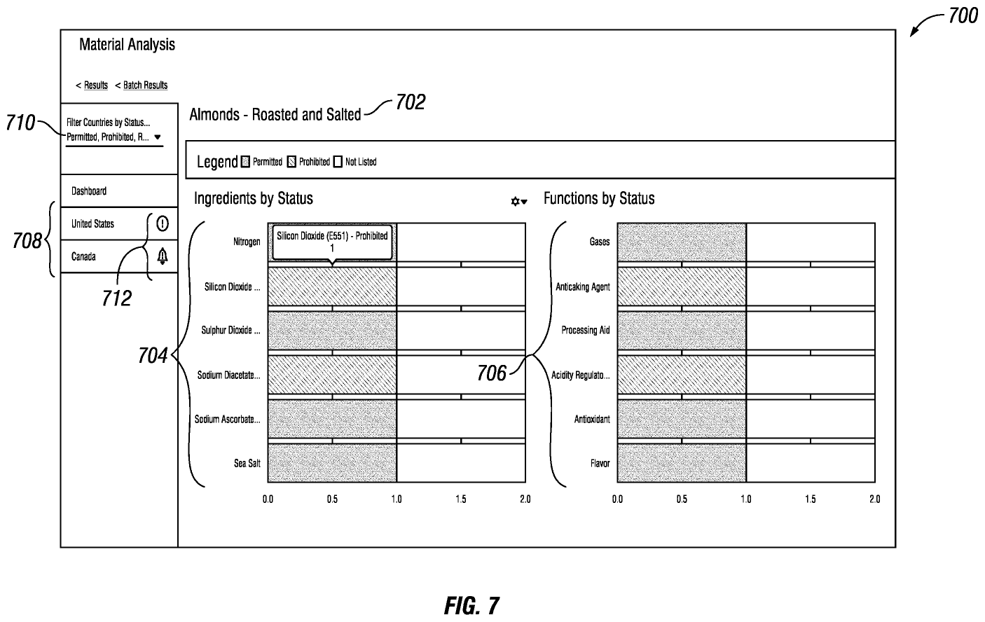

Referring to FIG. 7, an embodiment of detailed results used in product compliance analysis is illustrated. As shown in FIG. 7, an interface 700 is provided to an end user on a device 300 such as, for example, on a communication interface 370. In some examples, the device 300 is a vendor device 210 and/or compliance platform 220. The interface 700 may include information regarding a specific product 702 from the plurality of products that were analyzed. The information regarding the specific product 702 may include information about the compliance (e.g., permitted, prohibited, etc.) of the specific components 704 of the product (e.g., each individual ingredient in a food or beverage product). The information regarding the specific product 702 may include information about the compliance (e.g., permitted, prohibited, etc.) of the specific function 706 of each specific component 704 (e.g., sea salt is used for flavor). The interface 700 may include information regarding the selected countries 708 that were analyzed, which may include identifiers 712. The identifiers 712 (e.g., product prohibited, and/or more information required) provide an end user with a quick indication of whether a product requires changes to comply with the regulations of a particular country. The detailed results enable an end user to determine paths to remediation by showing the root of the compliance issues. Further, the detailed results enable an end user to generate scenarios and recommendations for remediation based on least change, broadest compliance, or the like.

### Additional Embodiments

The following descriptive embodiments are offered in further support of the disclosure:

In a first embodiment, novel aspects of the present disclosure are directed to a computing device for product compliance comprising one or more memories for storing instructions; and one or more processors. The one or more processors configured to execute the instructions to cause the one or more processors to: compare each of a plurality of products simultaneously against each of a plurality of regulations; flag one or more products from the plurality of products in response to the one or more products satisfying a condition with the plurality of regulations; aggregate the one or more flagged products; and produce compliance results, wherein the compliance results are a pre-defined dataset formatted with a pre-defined format.

In another aspect of the computing device of the first embodiment, wherein: each of the plurality of products comprises one or more components, each of the plurality of regulations comprises one or more requirements, the condition is satisfied when each of the one or more components match each of the one or more requirements, and the one or more memories stores additional instructions that, when executed by the one or more processors, causes the one or more processors to generate a designation for the one or more flagged products that satisfies the condition.

In another aspect of the computing device of the first embodiment, wherein: each of the plurality of products comprises one or more components; each of the plurality of regulations comprises one or more requirements; the condition is satisfied when one or more components does not have a requirement from the one or more requirements to be compared with; and the one or more memories stores additional instructions that, when executed by the one or more processors, causes the one or more processors to generate a designation for the one or more flagged products that satisfies the condition with the plurality of regulations.

In another aspect of the computing device of the first embodiment, wherein: each of the plurality of products comprises one or more components, each of the plurality of regulations comprises one or more requirements, the condition is satisfied when any one of the one or more components does not match with any of the one or more requirements, and the one or more memories stores additional instructions that, when executed by the one or more processors, causes the one or more processors to generate a designation for the one or more flagged products that satisfies the condition.

The computing device of the preceding aspect of the first embodiment, wherein: each of the plurality of regulations correspond to a different country; the one or more memories stores additional instructions that, when executed by the one or more processors, causes the one or more processors to: produce detailed results for each of the one or more flagged products that satisfy the condition, wherein the detailed results comprise identification of the one or more components for each of the one or more flagged products that satisfy the condition, and identification of one or more countries where the one or more flagged products satisfy the condition.

The computing device of the preceding aspect of the first embodiment, wherein: the one or more memories stores additional instructions that, when executed by the one or more processors, causes the one or more processors to provide alternative components for the one or more flagged products that satisfy the condition.

The computing device of the preceding aspect of the first embodiment, wherein the alternative components result in at least one of: a change to the one or more components that is below a threshold amount, compliance with a minimum threshold of countries, compliance with a required set of countries, or any combination thereof.

The computing device of the preceding aspect of the first embodiment, wherein: the one or more components comprise at least one of food class, chemical composition, formulation, and function; and the one or more requirements comprise at least one of food class, chemical composition, formulation, and function.

The computing device of any of the preceding aspects of the first embodiment, wherein the plurality of products comprises at least one of food, cosmetics, beverages, medication, or any combination thereof.

The computing device of any of the preceding aspects of the first embodiment, wherein the one or more memories stores additional instructions that, when executed by the one or more processors, causes the one or more processors to automatically and periodically run comparisons of the plurality of products against the plurality of regulations.

The computing device of the preceding aspect of the first embodiment, wherein the one or more memories stores additional instructions that, when executed by the one or more processors, causes the one or more processors to generate an alert of changes in the one or more flagged products that have satisfied the condition.

In a second embodiment, novel aspects of the present disclosure are directed to method comprising: receiving, by one or more computing resources of a compliance platform, information about a plurality of regulations; receiving, by the one or more computing resources of the compliance platform, information about a plurality of products; comparing, by the one or more computing resources of the compliance platform, each of the plurality of products simultaneously with each of the plurality of regulations; flagging, by the one or more computing resources of the compliance platform and based the comparison of each of the plurality of products simultaneously with each of the plurality of regulations, one or more products from the plurality of products in response to the one or more products satisfying a condition with the plurality of regulations; generating, by the one or more computing resources of the compliance platform and based on the one or more flagged products, a compliance result for each of the one or more flagged products; and aggregating, by the one or more computing resources of the compliance platform, the compliance result for each of the one or more flagged products.

The method of the preceding aspect of the second embodiment, wherein: each of the plurality of products comprises one or more components, each of the plurality of regulations comprises one or more requirements, and the condition is satisfied when each of the one or more components match each of the one or more requirements; and further comprising generating a designation for the one or more flagged products that satisfies the condition.

In another aspect of the method of the second embodiment, wherein: each of the plurality of products comprises one or more components, each of the plurality of regulations comprises one or more requirements, the condition is satisfied when any one of the one or more components does not match with any of the one or more requirements, and further comprising generating a designation for the one or more flagged products that satisfies the condition.

The method of the preceding aspect of the second embodiment, wherein: each of the plurality of regulations correspond to a country and further comprising: producing detailed results for each of the one or more flagged products that satisfy the condition, wherein the detailed results comprise: identification of the one or more components for each of the plurality of products that satisfy the condition, and identification of one or more countries where the one or more flagged products satisfy the condition.

The method of the preceding aspect of the second embodiment, further comprising providing alternative components for the one or more flagged products to create a match with the at least one of the plurality of requirements.

The method of the preceding aspect of the second embodiment, wherein providing alternative components for the one or more flagged products results in at least one of: a change to the one or more components that is below a threshold amount, compliance with a minimum threshold of countries, compliance with a required set of countries, or any combination thereof.

The method of any of the preceding aspects of the second embodiment, further comprising: periodically comparing the information about the plurality of products with the information about a plurality of regulations, and generating an alert upon changes in the one or more flagged products that have satisfied the condition.

In a third embodiment, novel aspects of the present disclosure are directed to a computing device for product compliance comprising one or more memories for storing instructions; and one or more processors. The one or more processors configured to execute the instructions to cause the one or more processors to: compare each of a plurality of products simultaneously with each of a plurality of regulations, wherein each of the plurality of products comprises one or more components, and wherein each of the plurality of regulations comprises one or more requirements; flag one or more products from the plurality of products in response to the one or more products satisfying one or more conditions with the plurality of regulations, wherein: a first condition is satisfied when the each of the one or more components match with each of the one or more requirements, a second condition is satisfied when any one of the one or more components does not match with any of the one or more requirements, and a third condition is satisfied when one or more components does not have a requirement from the one or more requirements to be compared with, generate a first designation for the one or more flagged products that satisfy the first condition; generate a second designation for the one or more flagged products that satisfy the second condition; generate a third designation for the one or more flagged products that satisfy the third condition; aggregate the one or more flagged products; produce compliance results, wherein the compliance results are a pre-defined dataset formatted with a pre-defined format; automatically and periodically run comparisons of each of the plurality of products against each of the plurality of regulations; and generate an alert of changes in the one or more flagged products that have satisfied the one or more conditions.

In another aspect of the computing device of the third embodiment, wherein: each of the plurality of regulations correspond to a different country; the one or more memories stores additional instructions that, when executed by the one or more processors, causes the one or more processors to: generate detailed results for each of the one or more flagged products that satisfy the second condition, wherein the detailed results comprise: identification of the one or more components for each of the plurality of products that satisfy the second condition, and identification of one or more countries wherein the one or more flagged products satisfy the second condition, provide alternative components for the one or more flagged products that satisfy the second condition to create a match with the one or more requirements, wherein the alternative components result in at least one of: a change to the one or more components that is below a threshold amount, compliance with a minimum threshold of countries, compliance with a required set of countries, or any combination thereof.

The computing device of any of the preceding aspects of the third embodiment, wherein the plurality of products comprises at least one of food, cosmetics, beverages, medication, or any combination thereof.

In a fourth embodiment, novel aspects of the present disclosure are directed to a non-transitory computer-readable medium that may store instructions. The instructions include one or more instructions that, when executed by one or more processors, cause the one or more processors to: receive information about a plurality of regulations; receive information about a plurality of products; compare each of the plurality of products simultaneously with each of the plurality of regulations; flag one or more products from the plurality of products in response to the one or more products satisfying a condition with the plurality of regulations; generate a compliance result for each of the one or more flagged products; and aggregate the compliance result for each of the one or more flagged products.

The non-transitory computer-readable medium of the preceding aspect of the fourth embodiment, wherein: each of the plurality of products comprises one or more components, each of the plurality of regulations comprises one or more requirements, the condition is satisfied when each of the one or more components match each of the one or more requirements, and additional instructions that, when executed by the one or more processors, generate a designation for the one or more flagged products that satisfies the condition.

In another aspect of the computer-readable medium of the preceding aspect of the fourth embodiment, wherein: each of the plurality of products comprises one or more components; each of the plurality of regulations comprises one or more requirements; the condition is satisfied when one or more components does not have a requirement from the one or more requirements to be compared with; and additional instructions that, when executed by the one or more processors, generate a designation for the one or more flagged products that satisfies the condition with the plurality of regulations.

In another aspect of the computer-readable medium of the preceding aspect of the fourth embodiment, wherein: each of the plurality of products comprises one or more components, each of the plurality of regulations comprises one or more requirements, the condition is satisfied when any one of the one or more components does not match with any of the one or more requirements, and additional instructions that, when executed by the one or more processors, generate a designation for the one or more flagged products that satisfies the condition.

The computer-readable medium of the preceding aspect of the fourth embodiment, wherein: each of the plurality of regulations correspond to a different country; additional instructions that, when executed by the one or more processors, causes the one or more processors: produce detailed results for each of the one or more flagged products that satisfy the condition, wherein the detailed results comprise identification of the one or more components for each of the one or more flagged products that satisfy the condition, and identification of one or more countries where the one or more flagged products satisfy the condition.

The computer-readable medium of the preceding aspect of the fourth embodiment, wherein: additional instructions that, when executed by the one or more processors, causes the one or more processors to provide alternative components for the one or more flagged products that satisfy the condition.

The computer-readable medium of the preceding aspect of the fourth embodiment, wherein the alternative components result in at least one of: a change to the one or more components that is below a threshold amount, compliance with a minimum threshold of countries, compliance with a required set of countries, or any combination thereof.

The computer-readable medium of the preceding aspect of the fourth embodiment, wherein: the one or more components comprise at least one of food class, chemical composition, formulation, and function; and the one or more requirements comprise at least one of food class, chemical composition, formulation, and function.

The computer-readable medium of any of the preceding aspects of the fourth embodiment, wherein the plurality of products comprises at least one of food, cosmetics, beverages, medication, or any combination thereof.

The computer-readable medium of any of the preceding aspects of the fourth embodiment, wherein additional instructions that, when executed by the one or more processors, causes the computer-readable medium to automatically and periodically run comparisons of the plurality of products against the plurality of regulations.

The computer-readable medium of the preceding aspect of the fourth embodiment, wherein additional instructions that, when executed by the one or more processors, causes the computer-readable medium to generate an alert of changes in the one or more flagged products that have satisfied the condition.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A computing device for product compliance comprising:
one or more memories for storing instructions; and
one or more processors configured to execute the instructions to cause the one or more processors to:
compare each of a plurality of products simultaneously against each of a plurality of regulations;
flag one or more products from the plurality of products in response to the one or more products satisfying a condition with the plurality of regulations;
produce compliance results, wherein the compliance results are a pre-defined dataset formatted with a pre-defined format; and
aggregate the one or more flagged products.

2. The computing device of claim 1, wherein:
each of the plurality of products comprises one or more components,
each of the plurality of regulations comprises one or more requirements,
the condition is satisfied when each of the one or more components match each of the one or more requirements, and
the one or more memories stores additional instructions that, when executed by the one or more processors, causes the one or more processors to generate a designation for the one or more flagged products that satisfies the condition.

3. The computing device of claim 1, wherein:
each of the plurality of products comprises one or more components,
each of the plurality of regulations comprises one or more requirements,
the condition is satisfied when any one of the one or more components does not match with any of the one or more requirements, and
the one or more memories stores additional instructions that, when executed by the one or more processors, causes the one or more processors to generate a designation for the one or more flagged products that satisfies the condition.

4. The computing device of claim 3, wherein:
each of the plurality of regulations correspond to a different country;
the one or more memories stores additional instructions that, when executed by the one or more processors, causes the one or more processors to:
produce detailed results for each of the one or more flagged products that satisfy the condition, wherein the detailed results comprise:
identification of the one or more components for each of the one or more flagged products that satisfy the condition, and
identification of one or more countries where the one or more flagged products satisfy the condition.

5. The computing device of claim 4, wherein the one or more memories stores additional instructions that, when executed by the one or more processors, causes the one or more processors to provide alternative components for the one or more flagged products that satisfy the condition.

6. The computing device of claim 5, wherein the alternative components result in at least one of:
a change to the one or more components that is below a threshold amount,
compliance with a minimum threshold of countries,
compliance with a required set of countries, or
any combination thereof.

7. The computing device of claim 1, wherein:
each of the plurality of products comprises one or more components,
each of the plurality of regulations comprises one or more requirements,
the condition is satisfied when one or more components does not have a requirement from the one or more requirements to be compared with, and
the one or more memories stores additional instructions that, when executed by the one or more processors, causes the one or more processors to generate a designation for the one or more flagged products that satisfies the condition with the plurality of regulations.

8. The computing device of claim 1, wherein the plurality of products comprises at least one of food, cosmetics, beverages, medication, or any combination thereof.

9. The computing device of claim 6, wherein:
the one or more components comprise information related to at least one of food class, chemical composition, formulation, and function, and
the one or more requirements comprise information related to at least one of food class, chemical composition, formulation, and function.

10. The computing device of claim 1, wherein the one or more memories stores additional instructions that, when executed by the one or more processors, causes the one or more processors to automatically and periodically run comparisons of the plurality of products against the plurality of regulations.

11. The computing device of claim 10, wherein the one or more memories stores additional instructions that, when executed by the one or more processors, causes the one or more processors to generate an alert of changes in the one or more flagged products that have satisfied the condition.

12. A method, comprising:
receiving, by one or more computing resources of a compliance platform, information about a plurality of regulations;
receiving, by the one or more computing resources of the compliance platform, information about a plurality of products;
comparing, by the one or more computing resources of the compliance platform, each of the plurality of products simultaneously with each of the plurality of regulations;
flagging, by the one or more computing resources of the compliance platform and based on the comparison of each of the plurality of products simultaneously with each of the plurality of regulations, one or more products from the plurality of products in response to the one or more products satisfying a condition with the plurality of regulations;
generating, by the one or more computing resources of the compliance platform and based on the one or more flagged products, a compliance result for each of the one or more flagged products; and
aggregating, by the one or more computing resources of the compliance platform, the compliance result for each of the one or more flagged products.

13. The method of claim 12, wherein:
each of the plurality of products comprises one or more components,
each of the plurality of regulations comprises one or more requirements, and
the condition is satisfied when each of the one or more components match each of the one or more requirements, and
further comprising generating a designation for the one or more flagged products that satisfies the condition.

14. The method of claim 12, wherein:
each of the plurality of products comprises one or more components,
each of the plurality of regulations comprises one or more requirements,
the condition is satisfied when any one of the one or more components does not match with any of the one or more requirements, and
further comprising generating a designation for the one or more flagged products that satisfies the condition.

15. The method of claim 14, wherein each of the plurality of regulations correspond to a country and further comprising:
producing detailed results for each of the one or more flagged products that satisfy the condition, wherein the detailed results comprise:
identification of the one or more components for each of the plurality of products that satisfy the condition, and
identification of one or more countries where the one or more flagged products satisfy the condition.

16. The method of claim 15, further comprising providing alternative components for the one or more flagged products to create a match with the at least one of the one or more requirements.

17. The method of claim 16, wherein providing alternative components for the one or more flagged products results in at least one of:
a change to the one or more components that is below a threshold amount,
compliance with a minimum threshold of countries,
compliance with a required set of countries, or
any combination thereof.

18. The method of claim 12, further comprising:
periodically comparing the information about the plurality of products with the information about a plurality of regulations, and
generating an alert upon changes in the one or more flagged products that have satisfied the condition.

19. A system utilizing a computing device comprising:
one or more memories for storing instructions; and
one or more processors configured to execute the instructions to cause the one or more processors to:
compare each of a plurality of products simultaneously with each of a plurality of regulations, wherein each of the plurality of products comprises one or more components, and wherein each of the plurality of regulations comprises one or more requirements;
flag one or more products from the plurality of products in response to the one or more products satisfying one or more conditions with the plurality of regulations,
wherein:
a first condition is satisfied when the each of the one or more components match with each of the one or more requirements,
a second condition is satisfied when any one of the one or more components does not match with any of the one or more requirements, and
a third condition is satisfied when one or more components does not have a requirement from the one or more requirements to be compared with,
produce compliance results, wherein the compliance results are a pre-defined dataset formatted with a pre-defined format;
generate a first designation for the one or more flagged products that satisfy the first condition;
generate a second designation for the one or more flagged products that satisfy the second condition;
generate a third designation for the one or more flagged products that satisfy the third condition;
aggregate the one or more flagged products;
automatically and periodically run comparisons of each of the plurality of products against each of the plurality of regulations; and
generate an alert of changes in the one or more flagged products that have satisfied the one or more conditions.

20. The computing device of claim 19, wherein:
each of the plurality of regulations correspond to a different country;
the one or more memories stores additional instructions that, when executed by the one or more processors, causes the one or more processors to:
generate detailed results for each of the one or more flagged products that satisfy the second condition, wherein the detailed results comprise:
identification of the one or more components for each of the plurality of products that satisfy the second condition, and
identification of one or more countries wherein the one or more flagged products satisfy the second condition,
provide alternative components for the one or more flagged products that satisfy the second condition to create a match with the one or more requirements, wherein the alternative components result in at least one of:
a change to the one or more components that is below a threshold amount,
compliance with a minimum threshold of countries,
compliance with a required set of countries, or
any combination thereof.
